(19) United States
(12) Patent Application Publication
(10) Pub. No.: US 2008/0037284 A1
(43) Pub. Date: Feb. 14, 2008

(54) Lightguide tile modules and modular lighting system

(76) Inventor: Charles A. Rudisill, Apex, NC (US)

Correspondence Address: Charles A. Rudisill, 3908 Bamburgh Ln., Apex, NC, 27539, US

(21) Appl. No.: 11/789,008

(22) Filed: Apr. 23, 2007

Related U.S. Application Data
(60) Provisional application No. 60/793,613, filed on Apr. 21, 2006.

(51) Int. Cl. F21V 8/00

(52) U.S. Cl. 362/629

(57) ABSTRACT

A modular illumination system includes light emitting tile modules, each module comprising a light guide substrate, at least one source of illumination optically coupled to a light guiding substrate and interconnection means to connect one light emitting tile module to another light emitting tile module. The interconnection means may include mechanical and/or electrical elements. A plurality of modules may be connected to create an extended continuous extended illuminating system without significant gaps or seams. In one embodiment, the light guiding substrate of one module extends over the source of illumination of an adjacent module. In a further embodiment, the light guiding substrate may be textured to create a patterned area with higher light extraction. In a further embodiment, the source of illumination may be included in a separate electrical member. The illumination sources may include LEDs directed into an edge of the light guiding substrate.

### FIELD OF INVENTION

This invention relates to functional and decorative lighting and backlighting applications.

### BACKGROUND OF THE INVENTION

In the area of backlighting such as for signage displays, video displays (LCDs), each application must be, for the most part, designed and engineered for each specific application. In many cases, particularly in signage, large bulky assemblies are required using fluorescent, incandescent, or custom engineered backlit light emitting diode (LED) systems. These systems also may be prone to heat, maintenance (bulb replacement, etc), and inefficiency.

Edge-lighted backlight systems using LEDs are confined to small to moderate sized displays because of the difficulty in providing an adequate number of LEDs along one or more edges to light large surfaces via conventional edge lighting.

Areas of use include utility and emergency lighting, home lighting, general lighting, under-cabinet lighting, illuminated tiled walls, industrial lighting, task lighting, architectural lighting, artistic lighting, backlighting of signage and other backlighting applications, hobbies and varied general decorative lighting applications.

The lighting system allows customizable sizes, shapes, colors, and textures, with low profile, and low power consumption.

The lighting system is low-cost, low profile (typically may be ¼ inch thick or less), mechanically robust, long life, and may be continuous without large seams between tile modules.

The modular system is also ideal for many backlighting applications. One drawback of many backlighting applications is that each backlighting solution must be designed and engineered for each application; for example, an edge-lighted lightguide type of backlight (e.g. for LCD displays), must be specifically designed and constructed for the particular light source used, illuminated area, allowable thickness, etc. In effect, this invention allows modular “mini” backlight units, to be assembled into any shape or size without custom engineering for each solution. Additionally, the overall area/size of conventional edge-lit lightguide backlights has a practical limitation because of the coupling efficiency, transmission losses, and difficulty in uniformly transmitting and scattering out of the lightguide over large surface areas.

Other backlighting methods such as large diffusely reflecting cavities require large cavity depths in order to obtain uniform illumination. Directly backlighting (without the use of light-guide types of diffusers) with the sources behind the viewing area creates problems with eliminating “hot spots” in the viewing area. Eliminating hot-spots is typically accomplished by increasing the cavity depth and adding additional internal diffusing means. Additionally, none of these methods is “modular” allowing flexibility in design (tile size, shape, thickness) and easy assembly into a variety of patterns.

Panelized decorative lighting is produced by companies such as Traxon Technologies; these products utilize a design which may be arrayed. However, these products are large, backlit assemblies, with a working depth of 1.2 to 3.75 inches, and areas of 200 or mqre square inches per tile. The Traxon products are interconnected with ribbon cables and controlled with sophisticated digital logic (DMX protocols, etc.). The Traxon products are expensive commercial and specialty lighting products. This invention differs in the following ways: tiles are very thin, typically less than 0.5 inches thick, are substantially edge lighted (versus back-lighted), may be made in many different sizes, shapes, colors, etc, and assembled into many combinations of shapes and sizes (versus large squares and rectangles), are generally about the sizes of standard ceramic tile (1 square inch to 64 square inches surface area), are low-cost items that may be purchased and installed by do-it-yourself consumers. Other approaches propose “flat panel” light emitting extended light sources such as organic LEDs (OLEDs). These are not based on lightguide designs.

### BRIEF SUMMARY OF THE INVENTION

Two basic variations in constructing the lightguide tile and modular lighting system are described.

In Method “A”, the lightguide substrate, light sources and electrical interconnections (to energize the light sources) between mating tiles are integrally contained in each lightguide tile module. When tiles are assembled to one another, multiple tiles are energized from adjacent tiles by a power source attached to one or more of the tiles. In Method “B”, the interconnection means is not integrated into the tile itself, but is accomplished through a secondary separate part(s); in method B, the light sources may be integrated into the tile, or the light sources installed into the power distribution base and the tile optically coupled to the LEDs when installed.

### BRIEF DESCRIPTION OF THE DRAWINGS

FIGS. 1A and 1B are top and bottom isometric views of a lightguide tile module using tongue and groove contacts

FIGS. 2A and 2B are top and bottom isometric views of an assembled array of lightguide tiles of FIG. 1.

FIGS. 3 and 4 are detail views of the tile shown in FIGS. 1 and 2. FIGS. 4B and 4C are cross-section views of the tile in FIG. 4A.

FIG. 5 is a schematic representation of and example of the electrical interconnections between tile modules.

FIG. 6 is an exploded view of a tile module using a printed circuit board and a tapered, overlapping lightguide which hides the light sources and seams between tile modules.

FIG. 7 is a cross-section view of the FIG. 6 tile module.

FIG. 8 is an array of the lightguide tile modules of FIGS. 6 and 7.

FIG. 9 shows the separate lightguide substrate of FIGS. 6-7 with a selectively textured area on the rear surface of the lightguide for forming a lighted pattern.

FIG. 10 shows the assembled tile module (according to FIGS. 6 and 7) and including a selectively textured lightguide substrate of FIG. 9 indicating the illuminated pattern resulting from the selectively textured area of FIG. 9.

FIGS. 11 and 12 are lightguide modules according to Method “B” where the light sources are powered by a separate grid.

FIG. 13 is an example of a triangular lightguide tile with embedded light sources that connect to a grid or backplane.

FIGS. 14A and 14B are top and bottom isometric views of a lightguide tile construction where the light sources are mounted underneath the tile viewing area and coupled with light pipes/guides that direct the light to the edge of the viewing area. FIG. 14C is a detail isometric view indicated in FIG. 14B. FIG. 14D is a cross-section detail view of FIG. 14C.

### DETAILED DESCRIPTION OF THE INVENTION

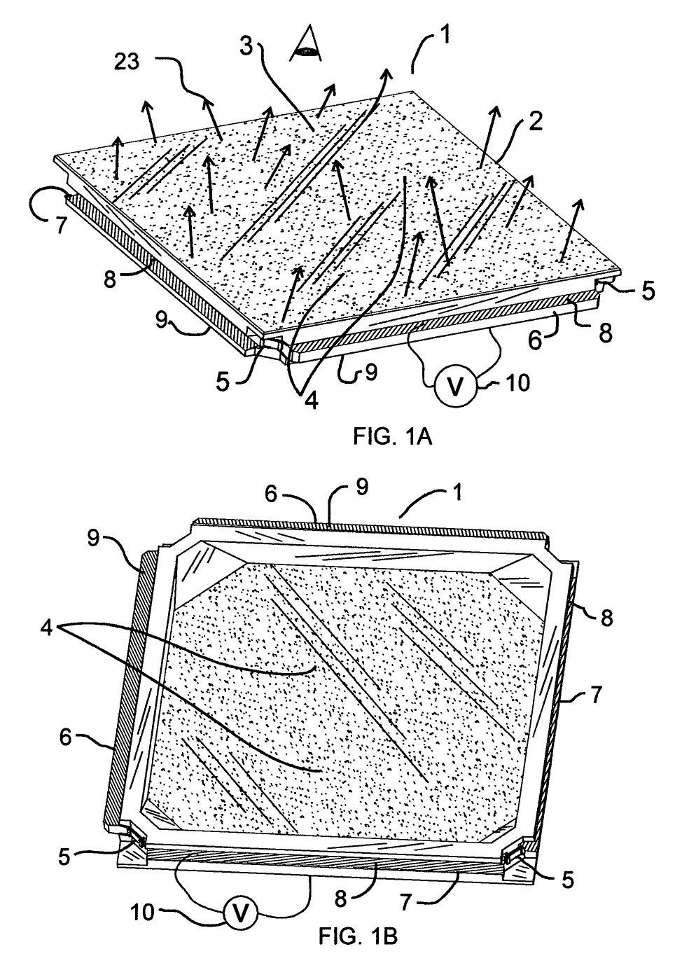

In an embodiment of Method A, and FIG. 1, the modular lightguide tile (1) is substantially edge lighted with LEDs (5). In this example, LEDs are located in the 4 corners and the LED light (23) output directed toward the center of the tile. The lightguide substrate (2) is made of a light transmitting material such as acrylic, polycarbonate or glass, functioning primarily as a light guide, or light-pipe, via transmission and total internal reflection. The primary viewing side (3) of each tile contains light-diffusing (4) means on one or more faces of the lightguide substrate (2), which reflects, refracts and/or diffuses the light (23) toward the viewing side of the tile. Each tile is provided electrical connection means, such that tiles may be attached to adjacent tiles, and the LEDs powered from a single (or multiple) power sources (10) and forming lighted arrays. In the example in FIGS. 1A and 1B tongues (6) along two adjacent sides and grooves (7) along two adjacent sides are incorporated into the lightguide substrate with positive electrodes (8) on one side of the tongues and grooves, and negative electrodes (9) along the opposing side of the tongues. Tongue and groove electrodes are electrically connected to LEDs (5), usually in parallel from one tile to the next. Such a design may be fabricated using methods such as insert-molding of conductors, 2-shot molding and plating, and conductive inks.

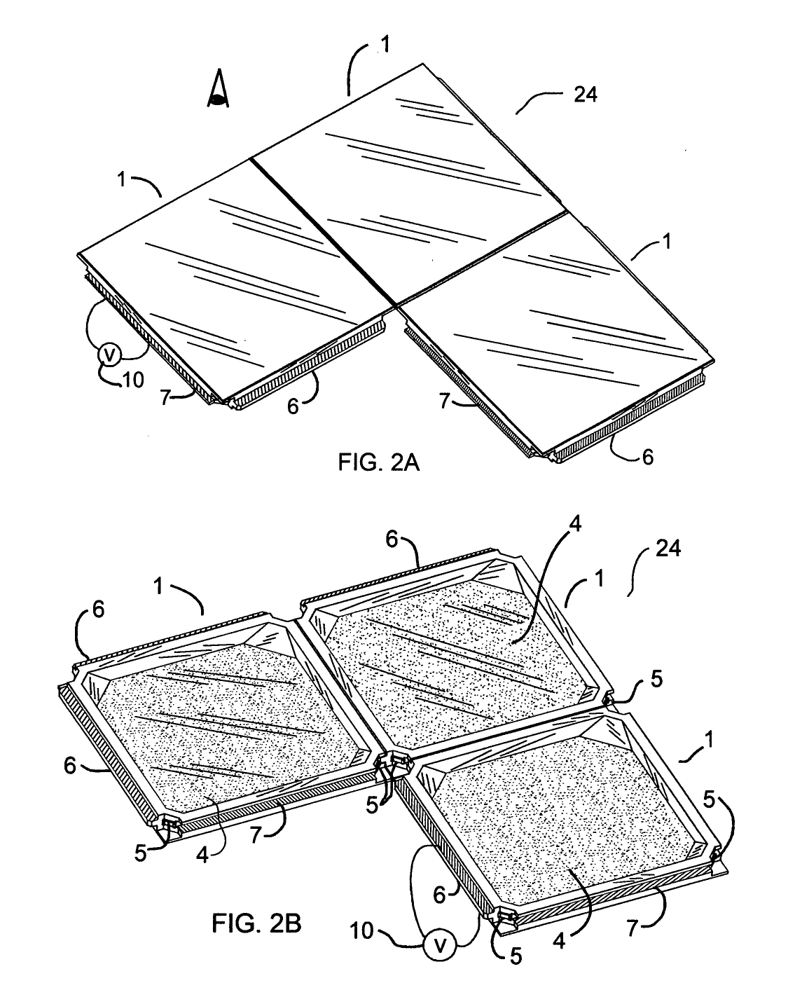

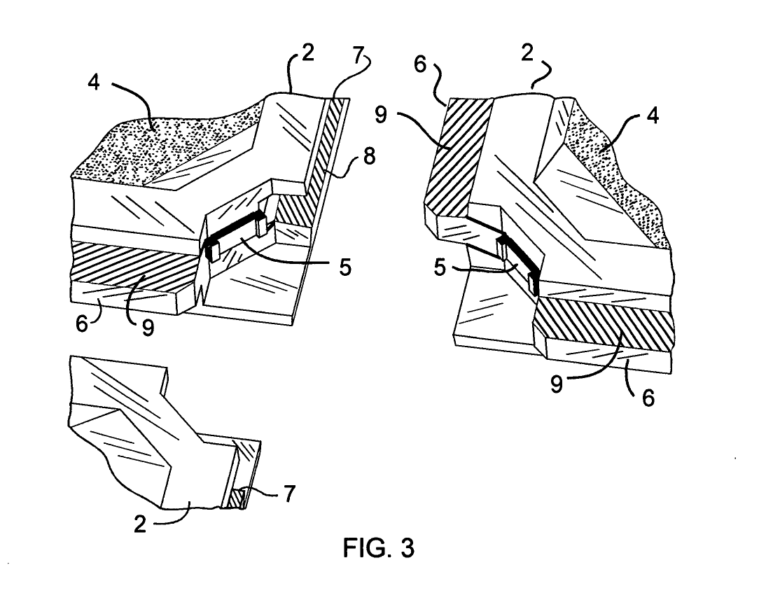

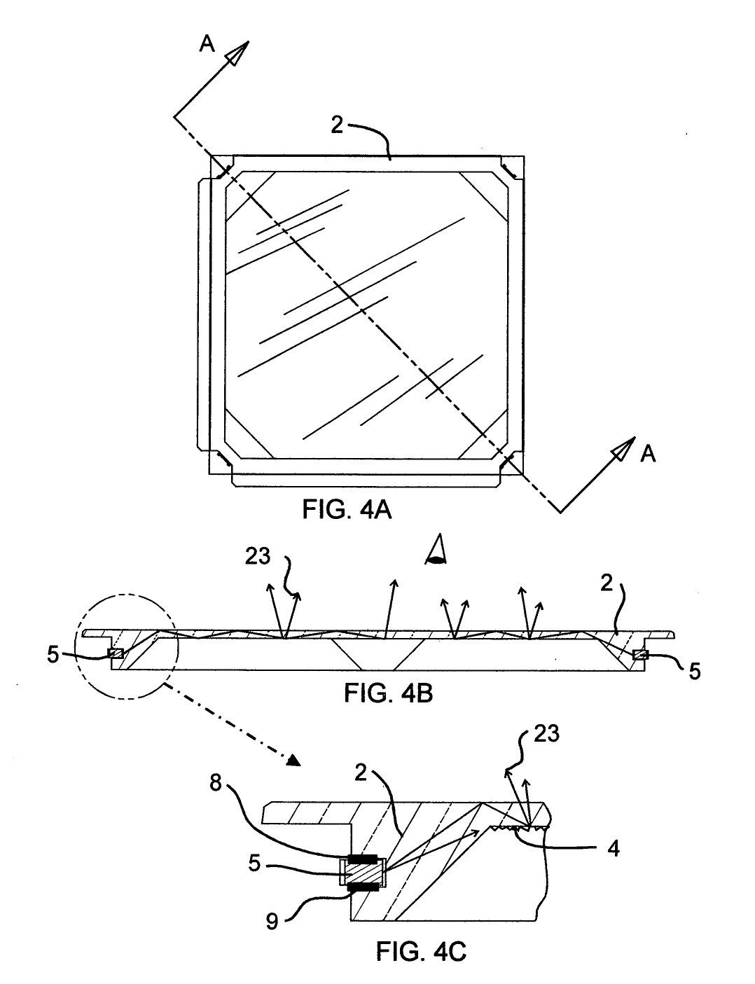

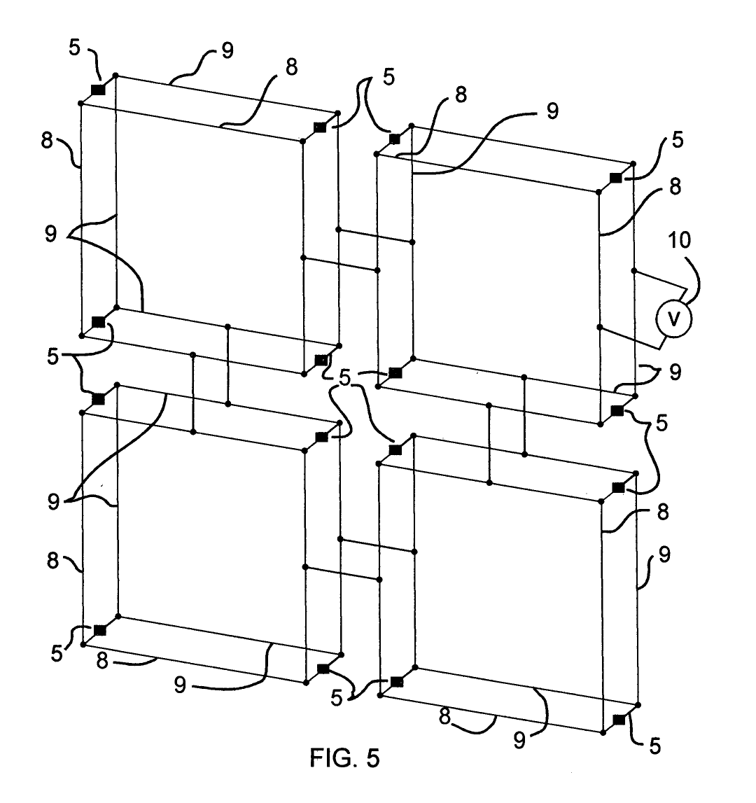

Consequently, the lightguide tile may be assembled into any configuration of arrays (24) with the tongues and grooves mated, (FIGS. 2A and 2B); each tile is electrically powered from any one mating side tongue and groove contact. FIG. 3 shows a detailed view of the top and bottom tongue and groove electrode arrangement in the corner area of three lightguide tiles before they are assembled into an array. Electrodes (8) (9), are connected in parallel to the LEDs (5). FIGS. 4A-4C show additional detail on the LED's (5) light output that is directed into the lightguide substrate (2) and propagates through the lightguide substrate by transmission and total internal reflection, before being directed out of the viewing side by the diffusing structures (4) located on the back and/or front of the viewing side of the lightguide substrate (2). FIG. 5 shows a schematic electrical representation of four tiles connected in parallel with a single power source (10); any one side that is connected to an adjacent tile is sufficient to power a number of tile modules. Thus a parallel interconnection is formed when two or more tiles are assembled together, and the tile may be located in any position (i.e. not fixed in rectilinear arrays) along the edges, or different sized tile attached to the tongues and grooves. The aforementioned examples show LEDs located in approximate corners of a square tile, but the LED configurations may be placed in many different configurations, some of which are described in the subsequent examples and figures.

The lightguide substrate (2) is made from an optically transparent/translucent material such as injection-molded polymers like polycarbonate or acrylic. Glasses and other types of resins (cast resins, compression-molded etc.) may also be used. One or more surfaces of lightguide substrate (2) (usually a combination of the front and back surface), is provided with a means for refracting, reflecting and/or diffusing the light from the LEDs out of the viewing side of the tile. This diffusing means (4) may be a regular or random texture (such as small facets, grooves, convex or concave dimples, etc. that are molded or embossed into the surface, or laser or mechanically engraved into the surfaces, diffusing paint/ink patterns printed onto one or more surfaces, molded-in inserts with diffuser patterns or adhesive applied diffuser patterns, or other variations in the overall shape of the lightguide substrate surface. Surfaces of the lightguide substrate may also be metallized with a reflective material such as evaporated aluminum to further control and direct light. The light intensity (output) on the viewing side of the lightguide tile may be made to appear nearly uniform (if desired) by proper gradation and design of these diffuser and reflecting/refracting structures (4). For example, the density of diffuser structures may increase as distance from the LED sources increases. These “uniformizing” methods are known in the art of backlighting of single displays such as for LCD display screens.

A variety of features to capture, direct, distribute and guide the light from the LEDs can be incorporated into the design of the tile including wedges, concave and convex lens-like structures, prisms, tapers, etc. molded into the lightguide substrate. Consequently, the tile may be made thin, translucent or transparent with minimal obstructions present on the major flat faces of the tile, allowing it to be also abutted and attached to other tile(s) resembling a typical floor, wall or ceramic tiled wall.

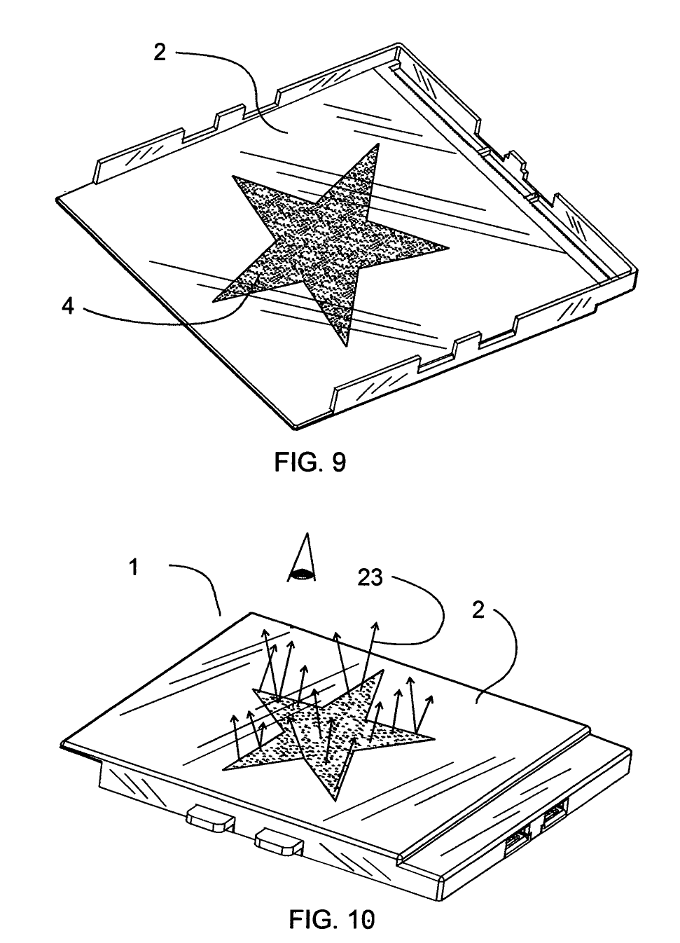

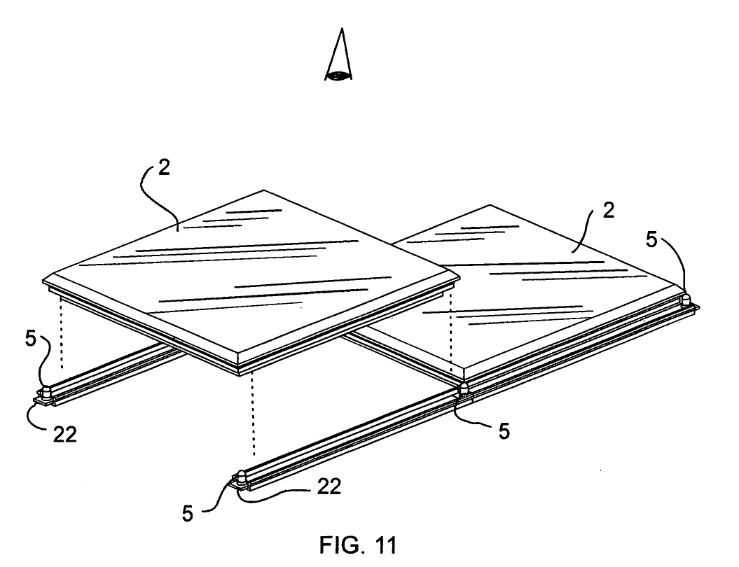

Rather than a uniformly illuminated viewing face, the viewing face may contain an endless variety of patterned appearances, pictures, shapes etc. as shown in the prototype example in FIGS. 9 and 10. The areas on one tile module are produced by selectively placed diffusing structures (4) on the smooth surface of the lightguide substrate (2). These patterns are incorporated into the light-diffusing/reflecting/refracting structures on one or both sides of the viewing face. The patterns are fabricated onto the flat smooth, primarily specular surfaces of the tile and appear illuminated when edge-lighted. The overall surface of the tile on the front and/or back may also contain various surface textures (such as wavy or “cathedral glass” type of appearances); these textures may still function primarily as a specular light guide, or may also partially reflect/refract/diffuse light out of the tile.

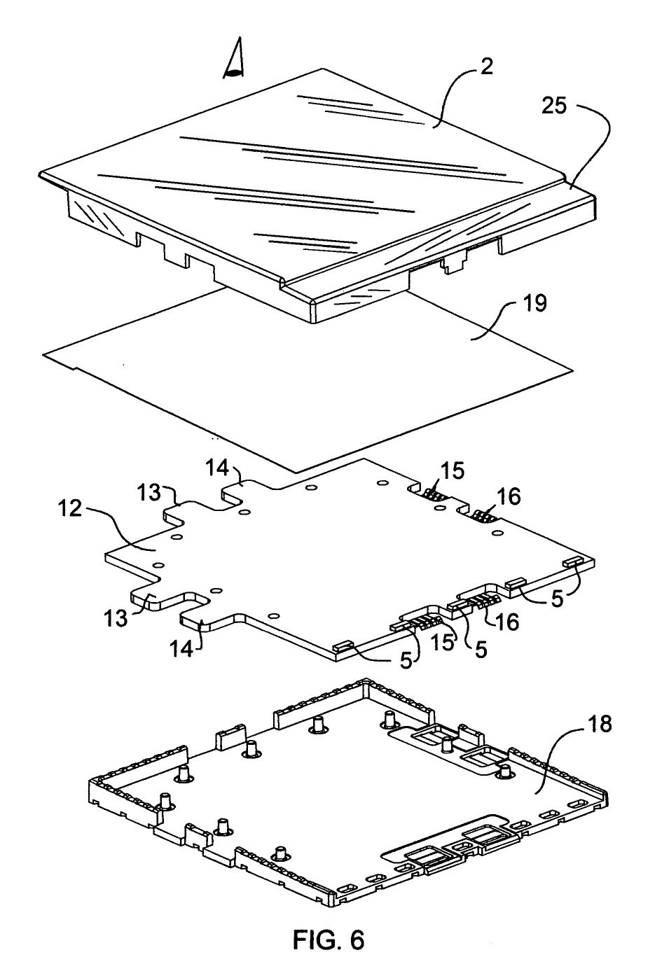

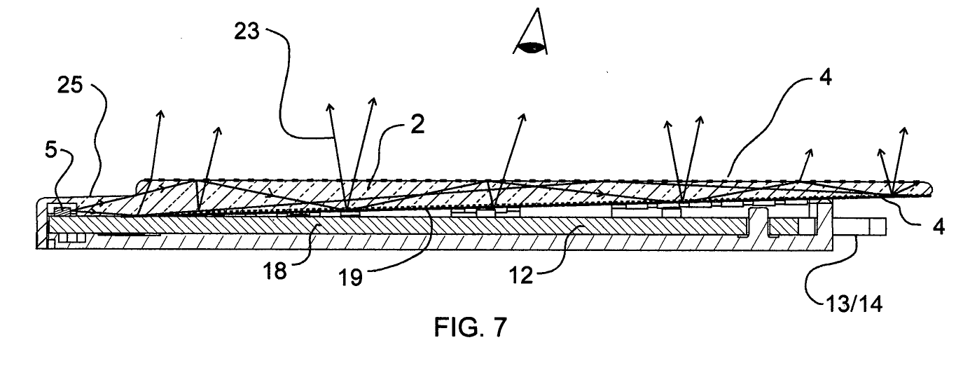

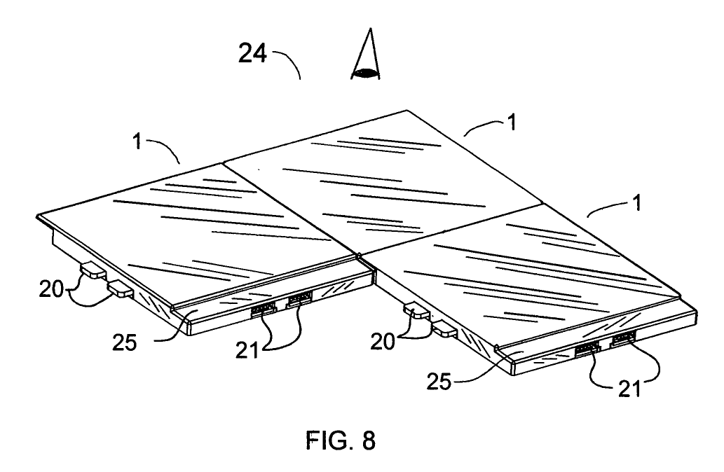

Another construction of lightguide tile is shown in FIGS. 6 and 7. In this design, the LEDs (5) are assembled onto a separate printed circuit board (12), along one edge, having discrete positive (13) and negative (14) “plug” tabs on adjacent sides of the PCB (12), and corresponding positive and negative spring contact receptacles (15) and (16) on the other adjacent sides. In this example, the LEDs (5) are positioned along one edge of the PCB. (Five LEDs are shown in this example but more or less may be added). The tabs may be integrally formed on the PCB in this example. The LEDs are connected with the circuitry on the PCB, and may be in series or parallel, or a combination thereof with current limiting resistors, or other control circuitry. More than two tabs/connections may be present on each side. Adjacent tile are preferably assembled in a parallel configuration as shown (positive tabs and receptacles mating on one or more sides). The lightguide substrate (2) in this example is tapered (see FIG. 7), and provided with a stepped area (25) such that the viewing area overlaps the LED area of an adjacent tile, so as to form a continuous extended lighted surface without significant seams or gaps between tiles. Obviously, other shapes and configurations of overlap are possible versus a taper, however the tapered lightguide (2) does not show any edges or features when viewed from the top-an advantage if seamless appearing tile viewing areas are desired. A bottom cover (18) encloses the lightguide tile module. A reflective sheet (19), made from materials such as white or metallized polyester film, functions as a rear reflector to increase light output to the viewing side, and also obscures all of the internal parts from view. A metallized coating on the back side of the viewing area will also hide the internal parts. When assembled, the parts basically form plugs (20) and receptacle (21) openings in the lightguide tile (FIG. 8). FIG. 8 shows multiple lightguide tiles assembled with mating tabs and receptacles, and the tapered area of the lightguide substrate overlapping and obscuring the LED area (25), forming a seamless lighted surface.

Generally, the LED sources are connected in parallel between adjacent tile modules to allow multiple tiles to be powered from a specified voltage. It is desirable to keep the tiles low-voltage (˜ less than 24 volts). Within each tile, the LEDs may be in series, parallel, or a combination of series-parallel with optional current limiting resistors, to provide the most efficient energy consumption based upon the required current and voltage rating for the desired number of LEDs

A power source (10) is connected to one or more of the tiles in an array. Since in a preferred embodiment, the tile are electrically connected in parallel, a single power source/transformer can supply a wide range of total number of tiles, and connected at any location within a grid of tile. A wall-mounted plug-in small AC or DC power supply with a connecter designed to interface with the edge of the tile may supply power, or customized decorative transformers in the shape of tile may be made. The power consumption is small with a typical LED requiring 15-25 mA/LED at 1.5-5 volts, so each tile (with 4 LEDs per tile) would draw approximately 0.08 amps and ˜2 watts.

In method B of this invention, the difference from Method A is primarily in the method of supplying power to the LEDs. Rather than the electrical interconnection between adjacent tile formed integrally with each tile, a separate part supplies power. The optical construction of the lightguide substrate is similar as described above. In Method B, the LEDs are supplied with power through a separate part.

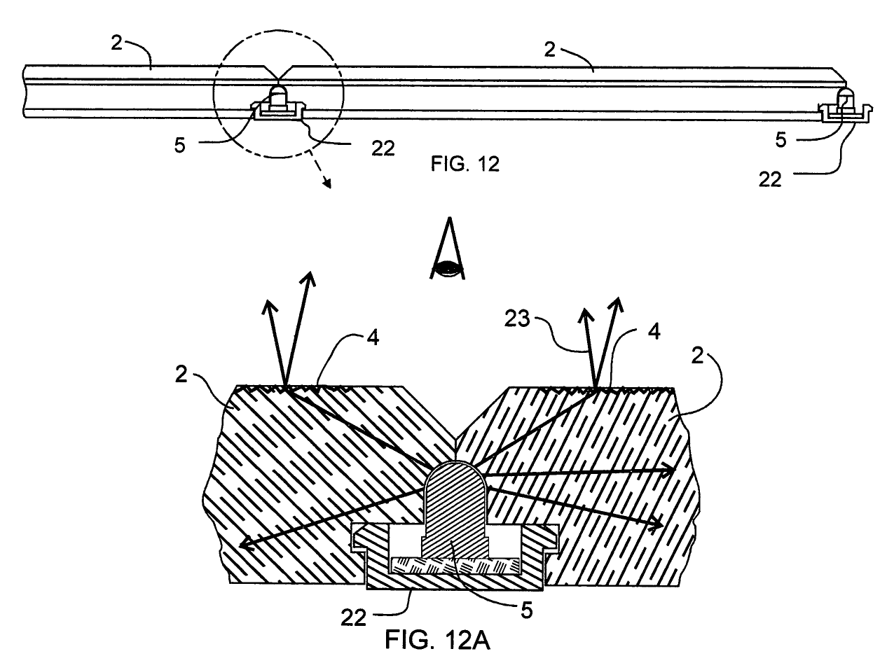

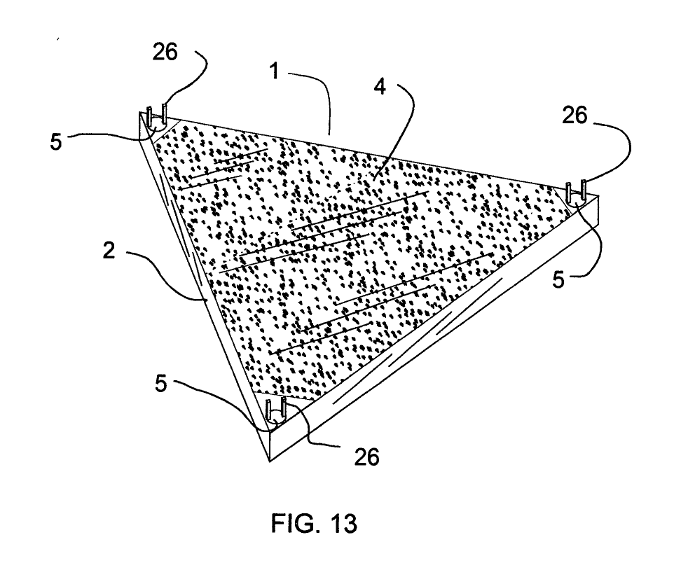

One such construction is shown in FIG. 11, whereby the LEDs (5) are affixed to a powered track (22) or grid, with a means of retaining and locating the tile with respect to the LEDs. When the lightguide substrate (2) is assembled to the power distribution base, the LEDs are optically coupled to the lightguide substrate as illustrated in FIGS. 12 and 12a. FIGS. 12 and 12a further illustrate an LED at the interstices of 4 tile corners, in which the output is shared by adjacent tile and optically coupled to the lightguide substrates (2). An endless variety and number of LEDs can be assembled (e.g. multiple LEDs along edges). The power distribution tracks (22) may be fabricated in different lengths/sizes and cut to suit the required installation. Such a power distribution grid, tracks etc, could for example be installed along a wall or floor, and tiles assembled to the grid; the grid or track also incorporates locating and retention features for the tile. The user could modify the number and color of LEDs.

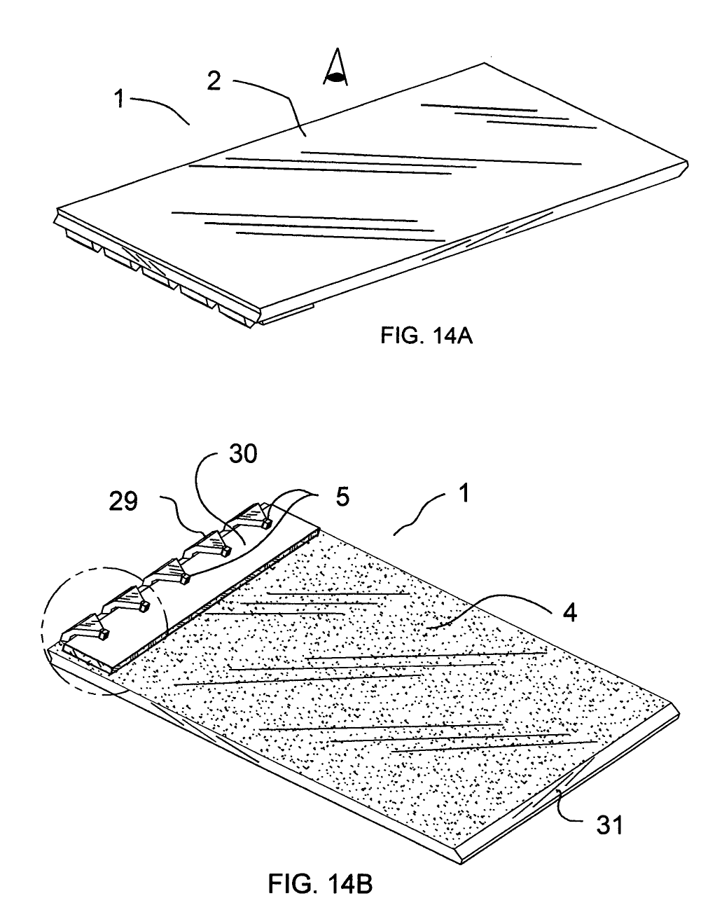

In another method, FIG. 13, the LEDs (5) may be permanently installed into the lightguide tile (1) (in this illustration showing a triangular-shaped tile (27)) with electrical connections (26) exposed that may be plugged into a mating track or grid that provides power to the LEDs.

Below are other features that may be incorporated into this invention:

Tile shapes and connector systems are not limited to x/y rectilinear arrays; contoured or curved, tessellated, 3-d surfaces styles of tiles may be constructed--virtually any geometric shape is possible.

Right-angled and other curved shapes of lightguide substrates or tiles may be fabricated.

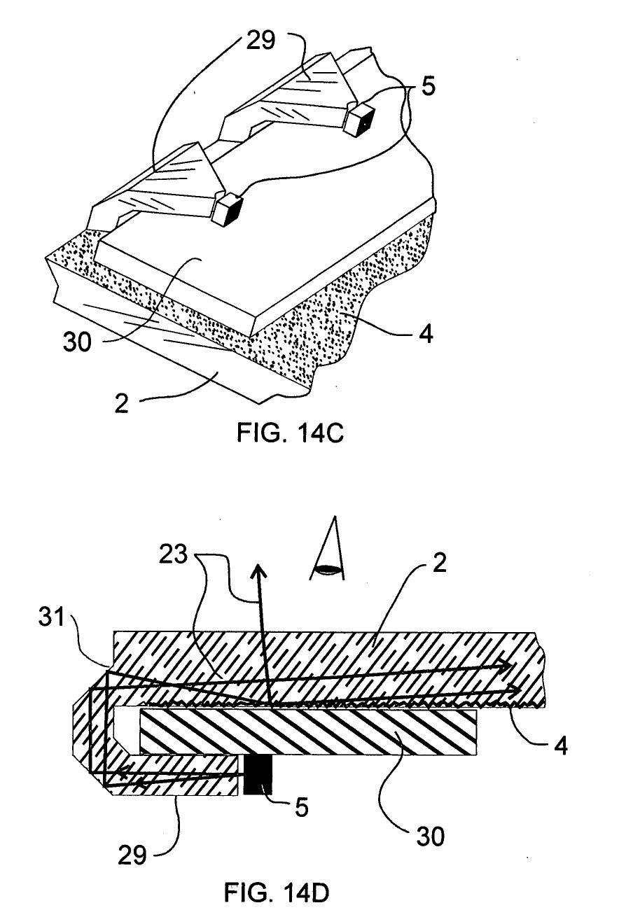

FIGS. 14A-14D illustrate another method of construction in which the LEDs (5) are mounted underneath the viewing area of the lightguide substrate (2) on a printed circuit carrier (30). A portion of the lightguide substrate acts as a light pipe (29) optically coupled to the LEDs to direct the light (23) to the viewing area through a series of reflections. The end geometry (31) of the lightguide substrate may be formed to provide a seamless appearance when multiple tiles are assembled.

Tiles may be attached to surfaces using methods such as adhesives, pressure sensitive adhesives, or mechanical fasteners. Separate grid and edge-retaining retaining structures or frames may also be made, into which individual tiles are fitted and retained.

Mechanical features may be incorporated into tiles to align and retain tiles and connections. The description above outlines a tongue and groove system, and snap-in track and connectors/terminals; however many other fastening/interlocking methods are possible, such as compliant snaps, pins, detents, vertical dovetails and detents, magnets, “Velcro”, etc., facilitating vertical or horizontal assembly of multiple tiles. Tiles may also be glued together using adhesives and tapes. Tiles may also be caulked or grouted.

Colors may be changed by the coloration of the substrate material, surface treatment (painting, decals, etc) and/or LED colors; multiple colors may be used in each tile.

It is also possible to illuminate an adjacent tile with an adjacent tile's LED source by coupling either the LED or a portion of the tile light-guiding surface to adjacent tile.

Edge connector systems for linear, rectangular and curved arrays which attach to the edges of tiles, forming electrical connection and/or cosmetic trimming of tiles, and “adapter” blocks for changes in direction, corners, etc, are among a variety of accessories.

Lighted tiles may be used for general lighting, accent lighting, backlighting, wall and ceiling, cabinet lighting, light sculpture (e.g. lighted mosaics).

This document describes a preferred embodiment as primarily edge-lighting; however, LEDs may also be located in the viewing field of the tile versus only on the edges/corners of tile.

In the description, viewing from one side of a tile is described; however both sides of a tile could be illuminated and viewed.

Tiles may be virtually any shape, size or thickness. Since the LED edge light and connector mechanical parts may be thin and low width, a range of thin to thick tiles are possible.

Decorative lenses, faces, films, and patterns may be painted or placed into or over the face of the tiles for varied effects. The modular tiles may be used for a myriad of backlighting applications such as lighted transparency displays, signage, etc.; each “tile” is a small uniform backlight that may be assembled into an endless combination of shapes and sizes to form large, uniformly illuminated areas.

Batteries may also be used to provide power.

LEDs are described because of low power and small size and multiple colors, but other illumination sources such as incandescent and CCF lamps could be used.

Other methods of electrically interconnecting the LEDs include flexible circuits, conductive ink, separate contact subassemblies molded or affixed to light guides, molded and conductively plated subassemblies, 2-shot molded and plated contacts and formed wire, strip, and/or stampings that can be insert-molded or post-assembled. LEDs may be wired in various series-parallel combinations.

In certain applications, it may be desirable not to have uniform intensity on each tile. Texturing or painting in specific areas on the tiles may illuminate unique and varied patterns. The shape/surface profile of the tile may also be changed to tailor light output and appearance.

Illustrations in the description are shown primarily as flat tiles, but the surface may be textured, 3-dimensional, painted—an endless variety.

Decorative moldings may be fabricated to “frame” around edges; these moldings may also contain the appropriate electrical connections (and transformers, etc) to one or more lightguide tile in an array.

1) A modular lightguide tile, used for creating extended modular lighting arrangements, comprising:
a) A transparent or translucent substrate that functions primarily as light-guide (or “light-pipe”), said light guide substrate containing light-diffusing means to reflect/refract/diffuse light from below illumination sources out of one or more viewing faces of the tile, and said translucent substrate containing features to capture, disperse and/or direct light from the light sources described below.
b) Illumination source(s) whose light output is coupled into the lightguide substrate where the light travels through the substrate via transmission and internal reflection.
c) Electrical interconnection means to energize said light sources.
d) Power source for energizing the light sources.

2) A modular lightguide tile of claim 1 (described in body as “Method “A”) wherein said light sources and electrical interconnection means to light sources are integrated directly into each individual lightguide tile. Lighted arrays being formed by attaching multiple tile that are energized through adjacent tile from one or more remote power sources.

3) The modular lighting system of (1) above (described in body as “Method “B”) wherein electrical interconnection is accomplished by a separate part that distributes power to the light sources, said light sources being either integrally attached to each tile and having electrical connection points, and/or said LED's being attached to a base power distribution means and optically coupled when the tile is installed onto the base.

4) The system of claim 1-3 wherein the light sources are LED's.

5) The system of claim 1-3 wherein said power source is a low-voltage power supply or transformer connected at one or more locations within an assembly of edge-lighted tile.

6) The system of claim 1-3 wherein LED's are positioned such that the LED's are outboard or underneath the viewing area of the tile, and when assembled to adjacent I tile, the LED's are underneath the adjacent tile's viewing area (the tile substrate being tapered or otherwise formed to overlap the adjacent tile), thereby obscuring the LED's and forming a continuous extended lighted viewing surface with minimal seams.

7) The system of claim 1-2 Wherein the electrical contacts contain a positive and negative plug, or tab, on at least on edge, and a mating positive and negative receptacle, or plug on at least one additional edge.

8) The system of claim 1-2 wherein the electrical contacts contain a top (positive) contact, and positioned below said top contact a bottom (negative) contact (or vise versa) along at least one edge of said module, and a corresponding set of mating parallel contacts on at least one additional edge.

9) The system of claim 1-3 wherein the lightguide substrate and module is 3-dimensional (such as for forming an illuminated 90 degree corner module which interfaces with the planar modules).

10) The system of claims 1-3 wherein said light guide diffusing structures form various illuminated patterns or pictures, or uniformly lighted viewing surfaces.

11) The system of claims 1-3 wherein active control components and circuitry are electrically connected to provide electronically controlled lighting effects.
